(19) United States
(12) Patent Application Publication
(10) Pub. No.: US 2017/0013118 A1
(43) Pub. Date: Jan. 12, 2017

(54) ELECTRONIC DEVICE AND NOTIFICATION METHOD THEREOF

(71) Applicant: Samsung Electronics Co., Ltd., Gyeonggi-do (KR)

(72) Inventors: Ji Hun LEE, Seoul (KR); Joo Yeon PARK, Seoul (KR); Hae Mi YOON, Seoul (KR); Hyun Yeul LEE, Seoul (KR)

(73) Assignee: Samsung Electronics Co., Ltd.

(21) Appl. No.: 15/207,015

(22) Filed: Jul. 11, 2016

(30) Foreign Application Priority Data
Jul. 10, 2015 (KR) 10-2015-0098690

(51) Int. Cl. H04M 1/725; G06F 3/0488; H04M 19/04; G06F 3/0481

(52) U.S. Cl. CPC H04M 1/72597; G06F 3/0481; G06F 3/0488; H04M 19/047; H04M 2250/22; H04M 2201/42

(57) ABSTRACT

An electronic device and a notification method of the electronic device are provided. The electronic device includes an input module configured to receive a user input, a display configured to display a user interface, and a processor configured to execute a first application if a notification event is generated, display an incoming call user interface provided by the first application, on the display, and provide a user with a conversation service through the first application if a call acceptance command is input from the user. The notification method of the electronic device includes executing, by the electronic device, a first application if a notification event is generated; displaying, on a display, an incoming call user interface provided by the first application; receiving, by the electronic device, a call acceptance command from a user; and providing, by the electronic device, the user with a conversation service through the first application.

### PRIORITY

This application claims priority under 35 U.S.C. §119(a) to a Korean Patent Application filed on Jul. 10, 2015 in the Korean Intellectual Property Office and assigned Serial number 10-2015-0098690, the entire content of which is incorporated herein by reference.

### BACKGROUND

1. Field of the Disclosure

The present disclosure relates, generally, to an electronic device that provides a notification when an event is generated and a notification method of the electronic device, and more particularly, to an electronic device that provides a notification through a user interface selected according to a type of notification and provides an additional service associated with a notification event and a notification method of the electronic device.

2. Description of the Related Art

With the development of electronic technologies, various types of electronic products have been developed and distributed. In particular, an electronic device, which has a variety of functions, such as a smartphone, a tablet personal computer (PC), or the like is widely available.

An electronic device may provide a notification service with respect to various events that the electronic device generates. For example, the electronic device may provide notification information on a display in the form of a pop-up window or a banner and may generate a sound or a vibration.

After providing a notification, an electronic device may not perform another operation associated with a notification. Moreover, the notification method is uniformly used regardless of a kind of application or a kind of notification event. Accordingly, a user is unable to determine whether a notification is an urgent permission event or an important notification event, until after confirming the content of the notification.

### SUMMARY

An aspect of the present disclosure is to provide an electronic device that provides a notification through a user interface selected according to a kind of notification and provides an additional service associated with a notification event and a notification method of the electronic device.

In accordance with an aspect of the present disclosure, an electronic device is provided. The electronic device includes an input module configured to receive a user input, a display configured to display a user interface, and a processor configured to execute a first application if a notification event is generated, display an incoming call user interface provided by the first application, on the display, and provide a user with a conversation service through the first application if a call acceptance command is input from the user.

In accordance with another aspect of the present disclosure, a notification method of an electronic device is provided. The notification method of the electronic device includes executing, by the electronic device, a first application if a notification event is generated, displaying, on a display, an incoming call user interface provided by the first application, receiving, by the electronic device, a call acceptance command from a user, and providing, by the electronic device, the user with a conversation service through the first application.

### BRIEF DESCRIPTION OF THE DRAWINGS

The above and other aspects, features, and advantages of the present disclosure will be more apparent from the following description, taken in conjunction with the accompanying drawings, in which:

FIG. 1 is a block diagram of an electronic device according to an embodiment of the present disclosure;

FIGS. 2A and 2B are diagrams illustrating a user interface provided at a first application, according to an embodiment of the present disclosure;

FIGS. 3A and 3B are diagrams illustrating a user interface provided at a first application, according to an embodiment of the present disclosure;

FIG. 4 is a flowchart of a notification method of an electronic device according to an embodiment of the present disclosure;

FIG. 5 is a flowchart of a method of providing a conversation service, according to an embodiment of the present disclosure; and

FIG. 6 is a flowchart of a notification method of an electronic device according to an embodiment of the present disclosure.

### DETAILED DESCRIPTION OF EMBODIMENTS OF THE PRESENT DISCLOSURE

Various embodiments of the present disclosure are described below with reference to the accompanying drawings. Accordingly, those of ordinary skill in the art will recognize that modification, equivalent, and/or alternative on the various embodiments described herein may be variously made without departing from the scope and spirit of the present disclosure. With regard to a description of the accompanying drawings, similar elements may be marked by similar reference numerals.

In the present disclosure, the expressions “have,” “may have,” “include,” “comprise,” “may include,” and “may comprise” used herein indicate existence of corresponding features (e.g., elements such as numeric values, functions, operations, or components), but do not exclude the presence of additional features.

In the present disclosure, the expressions “A or B,” “at least one of A and/or B,” or “one or more of A and/or B,” and the like used herein may include any and all combinations of one or more of the associated listed items. For example, the term “A or B,” “at least one of A and B,” and “at least one of A or B” may refer to all of the case (1) where at least one A is included, the case (2) where at least one B is included, and the case (3) where both of at least one A and at least one B are included.

The terms, such as “first,” “second,” and the like used herein may refer to various elements of various embodiments of the present disclosure, but do not limit the elements. For example, “a first user device” and “a second user device” may indicate different user devices regardless of the order or priority thereof. For example, without departing the scope and spirit of the present disclosure, a first element may be referred to as a second element, and similarly, a second element may be referred to as a first element.

It should be understood that when an element (e.g., a first element) is referred to as being “(operatively or communicatively) coupled with/to” or “connected to” another element (e.g., a second element), the element may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there is no intervening element (e.g., a third element).

According to the situation, the expression “configured to” used herein may be used interchangeably with, for example, the expressions “suitable for,” “having the capacity to,” “designed to,” “adapted to,” “made to,” and “capable of.” The term “configured to” does not indicate only “specifically designed to” in hardware. Instead, the expression “a device configured to” may indicate that the device is “capable of” operating together with another device or other components. For example, a “processor configured to (or set to) perform A, B, and C” may indicate a dedicated processor (e.g., an embedded processor) for performing a corresponding operation or a general purpose processor (e.g., a central processing unit (CPU) or an application processor (AP)) which performs corresponding operations by executing one or more software programs which are stored in a memory device.

Terms used in the present disclosure are used to describe certain embodiments, but are not intended to limit the scope of the present disclosure. The terms of a singular form may include plural forms unless otherwise indicated. All of the terms used herein may have the same meanings that are generally understood by a person skilled in the art. It should be further understood that terms, which are defined in a dictionary and commonly used, should also be interpreted as is customary in the relevant related art and not in an idealized or overly formal manner unless expressly so defined herein in an embodiment of the present disclosure. In some cases, even if terms are terms which are defined in the present specification, they may not be intended to be interpreted to exclude embodiments of the present disclosure.

For example, an electronic device according to an embodiment of the present disclosure may include at least one of smartphones, tablet PCs, mobile phones, video telephones, electronic book readers, desktop PCs, laptop PCs, netbook computers, workstations, servers, personal digital assistants (PDAs), portable multimedia players (PMPs), motion picture experts group (MPEG-1 or MPEG-2) audio layer 3 (MP3) players, mobile medical devices, cameras, or wearable devices. According to an embodiment of the present disclosure, a wearable device may include at least one of an accessory type of a device (e.g., a timepiece, a ring, a bracelet, an anklet, a necklace, glasses, a contact lens, or a head-mounted-device (HIVID)), one-piece of fabric or clothes type of a device (e.g., electronic clothes), a body-attached type of a device (e.g., a skin pad or a tattoo), or a bio-implantable type of a device (e.g., an implantable circuit).

According to an embodiment of the present disclosure, electronic devices may be home appliances. The home appliances may include at least one of, for example, televisions (TVs), digital versatile disc (DVD) players, audio players, refrigerators, air conditioners, cleaners, ovens, microwave ovens, washing machines, air cleaners, set-top boxes, home automation control panels, security control panels, TV boxes (e.g., Samsung HomeSync®, Apple TV®, or Google TV™), game consoles (e.g., Xbox® or PlayStation®), electronic dictionaries, electronic keys, camcorders, electronic picture frames, or the like.

Hereinafter, an electronic device according to an embodiment of the present disclosure may be described with reference to the accompanying drawings. The term “user” used herein may refer to a person who uses an electronic device or may refer to a device (e.g., an artificial intelligence electronic device) that uses an electronic device.

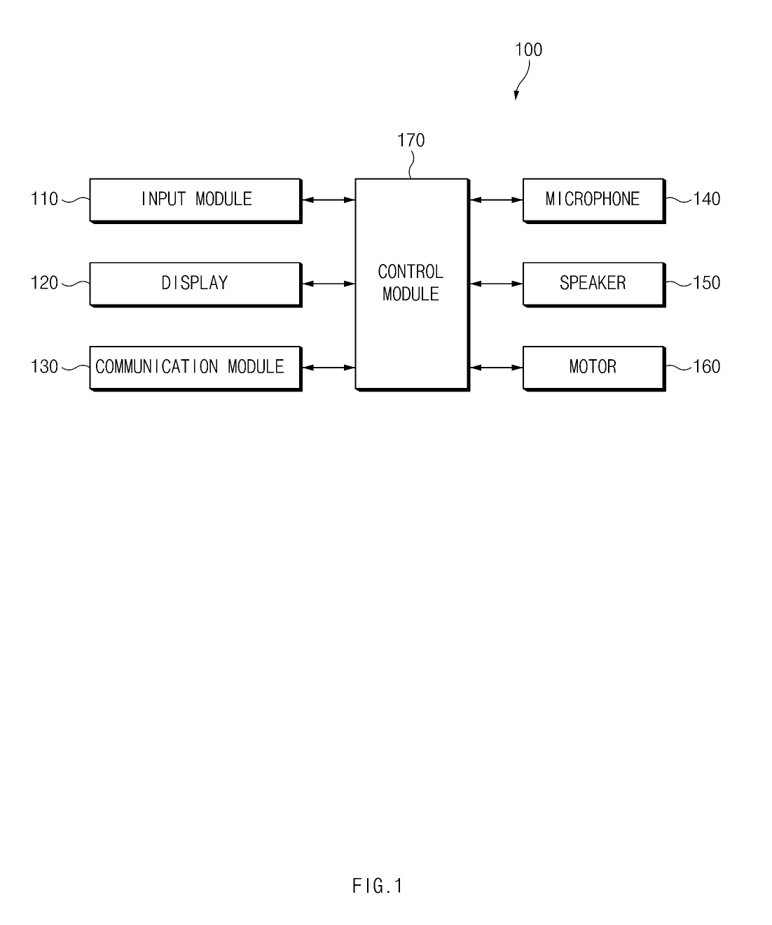

FIG. 1 is a block diagram of an electronic device 100 according to an embodiment of the present disclosure.

Referring to FIG. 1, the electronic device 100 may include an input module 110, a display 120, a communication module 130, a microphone 140, a speaker 150, a motor 160, and a control module 170.

The input module 110 may receive a user input. According to an embodiment of the present disclosure, the input module 110 may receive a call acceptance command from a user. In addition, the input module 110 may receive a call rejection command from a user. Furthermore, the input module 110 may receive a message change command from a user.

In an embodiment of the present disclosure, the input module 110 may include a touch sensor panel that senses a touch manipulation of a user or a pen sensor panel that senses a pen manipulation of a user. According to an embodiment of the present disclosure, the input module 110 may sense a user manipulation inputted by a user with the user's finger or a pen spaced apart from a panel by a certain distance, as well as a user manipulation inputted when the user directly makes contact with the panel (e.g., a touch sensor panel or a pen sensor panel).

According to an embodiment of the present disclosure, the input module 110 may receive, from a user, a user command for setting whether to receive an urgent notification. For example, a user may select whether to receive an urgent notification for each application or for each schedule.

The display 120 may display a user interface. According to an embodiment of the present disclosure, the display 120 may display an incoming call user interface that a first application provides. The first application may be a call application. For example, the first application may be a call application that is installed in the electronic device 100. For another example, the first application may be a call application providing a voice over long term evolution (VoLTE) service through a long term evolution (LTE) data communication network.

According to an embodiment of the present disclosure, if a call acceptance command is inputted from a user while an incoming call user interface is displayed on the display 120, the display 120 may display a call user interface during a call.

According to an embodiment an embodiment of the present disclosure, the display 120 may display a message user interface that a second application provides. The message user interface may include a message associated with a designated event. The second application may be a message application. For example, the second application may be a short message service (SMS) application that is installed in the electronic device 100. For example, the second application may be an instant message application.

According to an embodiment of the present disclosure, the input module 110 and the display 120, for example, may be implemented with a touch screen that is capable of displaying an image and sensing a touch manipulation at the same time. In the touch screen, the touch sensor panel may be disposed on the display 120.

The communication module 130 may communicate with an external device. According to an embodiment of the present disclosure, the communication module 130 may send and receive data through a network (e.g., a mobile communication network or an Internet network). The communication module 130 may include a cellular module, a wireless fidelity (Wi-Fi) module, a Bluetooth module, a near field communication (NFC) module, a global navigation satellite system (GNSS) module, and the like.

The microphone 140 may receive a voice input of a user and may convert the voice input into an audio signal. For example, the microphone 140 may receive, from a user, content of a conversation in an audio format.

The speaker 150 may convert an audio signal into sound and may output the sound. According to an embodiment of the present disclosure, if a notification event is generated, the speaker 150 may output a notification sound. The speaker 150 may output information about a notification event vocally. The speaker 150 may output a response message corresponding to the voice of a user vocally.

According to an embodiment of the present disclosure, the speaker 150 may include a plurality of speakers. A first speaker may output sound in a normal mode, and a second speaker may output sound in a speakerphone mode.

The motor 160 may convert an electrical signal into a mechanical vibration. According to an embodiment of the present disclosure, the motor 160 may generate the following effects: a vibration, a haptic effect, or the like. If the notification event is generated, the speaker 150 may generate a vibration for a notification.

The control module 170 may control an overall operation of the electronic device 100. According to an embodiment of the present disclosure, the control module 170 may control the input module 110, the display 120, the communication module 130, the microphone 140, the speaker 150, and the motor 160 to provide a notification. The control module 170 (e.g., an AP) may be implemented with a system on chip (SoC) including a processor (or a CPU), a graphics processing unit (GPU), a video processor, a memory, and the like.

According to an embodiment of the present disclosure, the control module 170 may determine whether a designated notification event (or an urgent notification event) is generated based on at least one of a user setting of a notification event, whether a user responds to a notification event, a location of an electronic device, a time, a word included in a notification event, or a caller of a notification event. The designated notification event may be, for example, an urgent notification event or a notification event of which the importance is high.

According to an embodiment of the present disclosure, if a notification event set to an urgent notification by a user is generated, the control module 170 may determine that the designated notification event is generated. For example, when a new schedule is added or when an existing schedule is changed, a schedule application may provide a menu for setting an urgent notification. When adding or changing a schedule, a user may set whether to receive an urgent notification. If a notification event set to an urgent notification arrives, the control module 170 may determine that a designated notification event is generated. For example, if mail or a message is sent, a mail or a message application may provide a user with a menu for setting an urgent notification. If mail or a message is sent, a user may set whether to receive an urgent notification. If an urgent notification is set in a received mail or message, the control module 170 may determine that a designated notification event is generated.

According to an embodiment of the present disclosure, if a number of responses to a notification is greater than or equal to a designated value, the control module 170 may determine that a designated notification event is generated. For example, if a number of responses to a notification is greater than or equal to a certain value (e.g., two) designated with respect to a notification event set to repeatedly generate a notification, the control module 170 may determine that a designated notification event is generated.

According to an embodiment of the present disclosure, if mail or a message is received from a designated caller, the control module 170 may determine that a designated event is generated. For example, a user may register a caller by using a mail address, a name, a telephone number, or the like of the caller. If mail or a message is received, the control module 170 may determine whether a caller corresponds to a caller registered by a user by verifying the caller of the mail or the message.

According to an embodiment of the present disclosure, if mail or a message in which a designated word is included is received, the control module 170 may determine that a designated event is generated. For example, if mail or a message is received, the control module 170 may analyze a title and a content of the mail or the message. If a word, for example, “urgently,” “quickly,” “immediately,” or the like is included in a received mail or message, the control module 170 may determine that a designated event is generated. For example, if schedule information (e.g., a time, a place, or the like) is included in a received mail or message, the control module 170 may determine that a designated event is generated.

According to an embodiment of the present disclosure, if a user approaches a location set by a user, the control module 170 may determine that a designated event is generated. For example, a user may register a place, a restaurant, or the like, for which the user searches by using the electronic device 100, as a place of interest. The control module 170 may determine a current location of the electronic device 100 by using information received from a Wi-Fi module, a GNSS module, or the like. If there is a place or a restaurant, which is registered by a user, in the vicinity of the current location of the electronic device 100, the control module 170 may determine that a designated event is generated.

According to an embodiment of the present disclosure, if it is determined that a movement time for moving to a location included in a schedule is equal to a remaining time between a current time and a time included in the schedule or that the movement time is less than the remaining time, the control module 170 may determine that a designated notification event is generated. For example, the control module 170 may determine a current location of the electronic device 100 by using information received from a Wi-Fi module, a GNSS module, or the like. The control module 170 may calculate a movement time for moving from a current location to a location included in a schedule by comparing the current location of the electronic device 100 and the location included in the schedule. The control module 170 may determine that a designated notification event is generated by comparing a movement time for moving to a location included in a schedule with a remaining time between a current time and a time included in the schedule.

According to an embodiment of the present disclosure, if a group schedule is changed, the control module 170 may determine that a designated notification event is generated. For example, if a group schedule is changed by any other user, the control module 170 may determine that a designated notification event is generated. In this case, the group schedule may be a schedule that a plurality of users shares. For example, if a group schedule is generated, a plurality of users included in a group may share information of the group schedule, and thus the group schedule may be applied in common to the plurality of users.

According to an embodiment of the present disclosure, if a designated notification event is generated, the control module 170 may display an incoming call user interface provided by a first application, on the display 120 by executing the first application. The incoming call user interface may include a call acceptance object, a call rejection object, and a message change object of a text or an icon.

According to an embodiment of the present disclosure, if a designated notification event is generated, the control module 170 may execute a first application to provide a notification based on a method set for the first application. For example, if a designated notification event is generated, the control module 170 may output a bell sound through the speaker 150 or may generate a vibration by using the motor 160 for each designated time interval. Alternatively, the control module 170 may generate a bell sound or a vibration at the same time.

According to an embodiment of the present disclosure, if a notification event is generated, not a designated notification event, the control module 170 may provide a notification based on a method different from a method set for a first application. For example, the control module 170 may provide a user with a notification based on a method provided at an application (e.g., a schedule application or an instant message application) in which a notification event is generated. For example, the control module 170 may display a popup window including notification information on the display 120 or may generate a designated sound or a vibration by using the speaker 150 or the motor 160.

According to an embodiment of the present disclosure, the control module 170 may receive a user command with an incoming call user interface displayed on the display 120. A user may input a user command through a touch sensor panel. For example, a user may input a user command by touching or dragging an object displayed on an incoming call user interface. A user may input a user command vocally. For example, if an incoming call user interface is displayed on the display 120, the microphone 140 may be activated. The control module 170 may recognize a voice of a user received through the microphone 140.

According to an embodiment of the present disclosure, if a call accepting command is inputted from a user, the control module 170 may provide a user with a conversation service through a first application. For example, the control module 170 may establish a virtual call channel between the electronic device 100 and a user to provide a conversation service. That is, a user may make a call to the electronic device 100 through the first application.

According to an embodiment of the present disclosure, if a call acceptance command is inputted from a user while an incoming call user interface is displayed on the display 120, the control module 170 may display a call user interface during a call.

According to an embodiment of the present disclosure, if a conversation service starts, the control module 170 may output information associated with a notification event vocally through the speaker 150. For example, the control module 170 may notify a user that mail is received from a certain user or may notify the user of schedule information.

According to an embodiment of the present disclosure, if a conversation service starts, the control module 170 may recognize a voice of a user received through the microphone 140 and may perform an operation corresponding to the recognized voice of the user. For example, if a call or a message to be sent to a user is requested by another user, the control module 170 may request the user to make call through the communication module 130 or may send a message for making the call to the user. For example, the control module 170 may add a new schedule to a schedule application. For example, if a question is received from a user, the control module 170 may search for an answer to the question on a web network.

According to an embodiment of the present disclosure, if a conversation service starts, the control module 170 may recognize a voice of a user received through the microphone 140 and may output a response message corresponding to the voice of the user through the speaker 150. For example, the control module 170 may control the speaker 150 to output a response to a question from a user vocally.

According to an embodiment of the present disclosure, the control module 170 may set a vocal output mode of the speaker 150 differently, based on an input path of a call acceptance command. For example, if a user command is input through the input module 110 (e.g., a touch sensor panel), the control module 170 may set the speaker 150 such that the speaker 150 operates in a normal mode. For example, if a user command is input through the microphone 140, the control module 170 may set the speaker 150 such that the speaker 150 operates in a speakerphone mode. The normal mode may be, for example, a mode in which the output of the speaker 150 is set to be small, for example, is set such that a user hears sound while the speaker 150 is placed around the ear of the user or a mode in which a first speaker of which the output is small is used. The speakerphone mode may be, for example, a mode in which the output of the speaker 150 is set to be loud, for example, is set such that a user recognizes sound while the speaker 150 is spaced apart from the ear of the user or a mode in which a first speaker of which the output is loud is used.

According to an embodiment an embodiment of the present disclosure, if a message change command is input from a user, the control module 170 may display a message user interface, which a second application provides, on the display 120 by executing the second application. In the case where a user wants to receive information about a notification event in a form of a message, the user may input a message change command. A message user interface may include a message associated with a designated notification event. That is, the electronic device 100 may provide a user with information associated with a designated notification event in a form of a message. The message user interface may include an object for performing an operation associated with a designated notification event. The message user interface may include an object of a text or an icon.

According to an embodiment of the present disclosure, if an object is selected by a user, the control module 170 may perform an operation corresponding to the selected object.

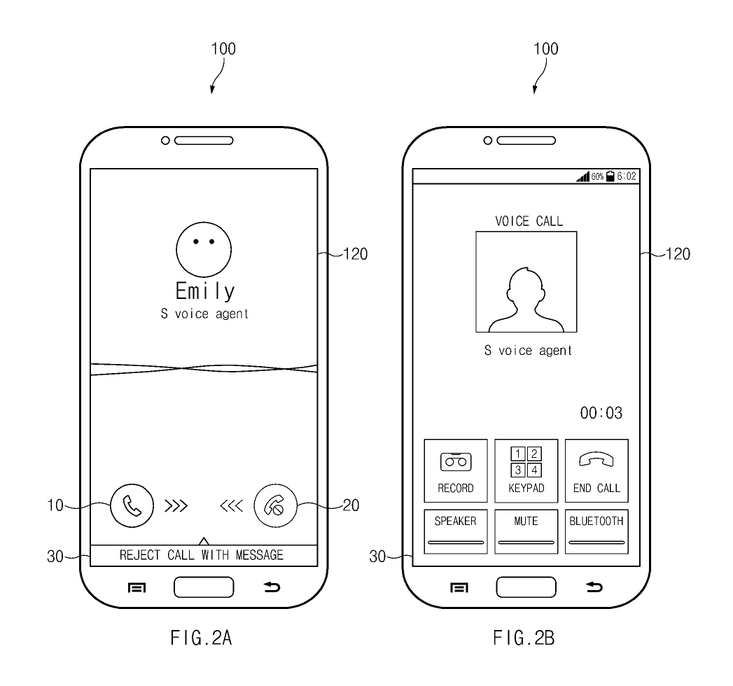

FIGS. 2A and 2B are diagrams illustrating a user interface provided at a first application, according to an embodiment of the present disclosure.

Referring to FIG. 2A, if a designated notification event is generated, the electronic device 100 may display an incoming call user interface provided by a first application, on the display 120 by executing the first application. The incoming call user interface may include a call acceptance object 10, a call rejection object 20, and a message change object 30 of a text or an icon.

According to an embodiment of the present disclosure, a user may input a call acceptance command by using the call acceptance object 10 displayed on the display 120. Alternatively, the user may input a call acceptance command vocally.

According to an embodiment of the present disclosure, if a call acceptance command is input from a user while an incoming call user interface is displayed on the display 120, the electronic device 120 may display a call user interface during a call as illustrated in FIG. 2B.

According to an embodiment an embodiment of the present disclosure, if a call accepting command is input from a user, the electronic device 100 may provide the user with a conversation service through a first application. Accordingly, the electronic device 100 may provide the user with a user experience equivalent to making a call.

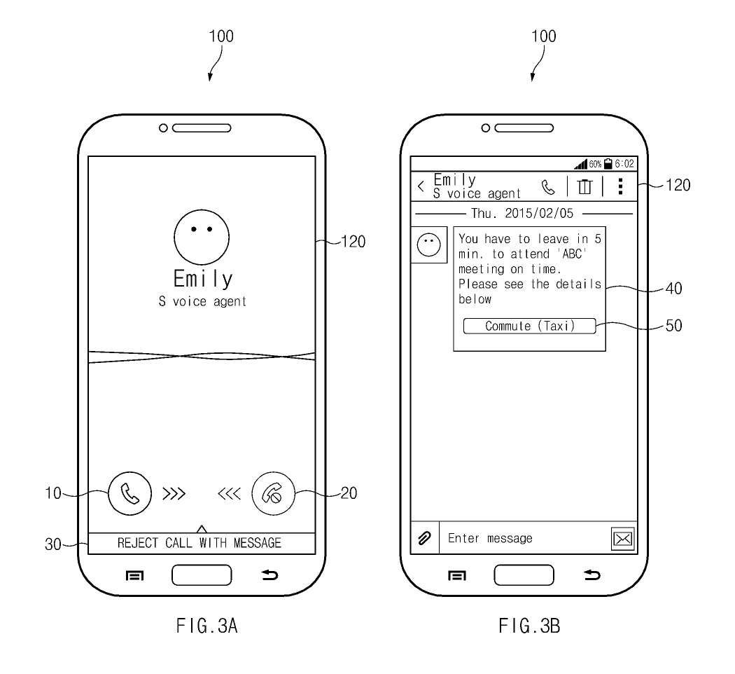

FIGS. 3A and 3B are diagrams illustrating a user interface provided at a first application, according to an embodiment of the present disclosure.

Referring to FIG. 3A, if a designated notification event is generated, the electronic device 100 may display an incoming call user interface provided by a first application, on the display 120 by executing the first application. The incoming call user interface may include the call acceptance object 10, the call rejection object 20, and the message change object 30 of a text or an icon.

According to an embodiment of the present disclosure, a user may input a message change command by using the call acceptance object 30 displayed on the display 120. Alternatively, a user may input a message change command vocally.

According to an embodiment of the present disclosure, if a call acceptance command is input from a user while an incoming call user interface is displayed on the display 120, the electronic device 120 may display a call user interface, during a call, as illustrated in FIG. 3B.

Referring to FIG. 3B, a message user interface may include a message 40 associated with a designated notification event. According to an embodiment of the present disclosure, a message user interface may include an object 50 for performing an operation associated with a designated notification event. If the object 50 is selected by a user, the electronic device 100 may perform an operation corresponding to the selected object 50. For example, the electronic device 100 may call a taxi company or may reserve a taxi through a web page of a taxi company.

According to an embodiment of the present disclosure, if a designated notification event is generated, the electronic device 100 may provide a user with a notification based on a manner in which an incoming call is received by using a call application that users frequently use. Moreover, in the case where a user accepts a call, the electronic device 100 may provide a user with a natural user experience such as making a call by providing the user with a conversation service associated with a notification event.

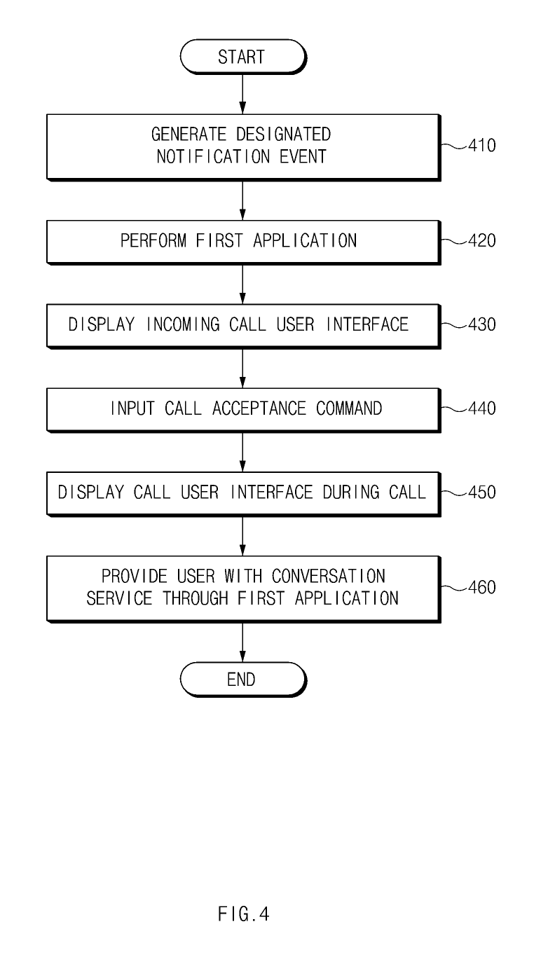

FIG. 4 is a flowchart of a notification method of an electronic device according to an embodiment of the present disclosure.

The flowchart illustrated in FIG. 4 may include operations that the electronic device 100 illustrated in FIG. 1 processes. The above description concerning the electronic device 100 illustrated in FIG. 1 may be applied to the method illustrated in FIG. 4.

Referring to FIG. 4, in step 410, a designated notification event may be generated in the electronic device 100. According to an embodiment of the present disclosure, the electronic device 100 may determine whether a designated notification event (or an urgent notification event) is generated based on at least one of a user setting of a notification event, whether a user responds to a notification event, a location of the electronic device 100, a time, a word included in a notification event, or a caller of a notification event.

According to an embodiment of the present disclosure, if a notification event set to an urgent notification by a user is generated, the electronic device 100 may determine that a designated notification event is generated. If a number of responses to a notification is greater than or equal to a designated value, the electronic device 100 may determine that a designated notification event is generated. If mail or a message is received from a designated caller, the electronic device 100 may determine that a designated event is generated. If mail or a message in which a certain word is included is received, the electronic device 100 may determine that a designated event is generated. If a user approaches a location set by a user, the electronic device 100 may determine that a designated event is generated. If it is determined that a movement time for moving to a location included in a schedule is equal to a remaining time between a current time and a time included in a schedule or that the movement time is less than the remaining time, the electronic device 100 may determine that a designated notification event is generated. If a group schedule is changed, the electronic device 100 may determine that a designated notification event is generated.

If a designated notification event is generated, in step 420, the electronic device 100 may execute a first application. According to an embodiment of the present disclosure, the first application may be a call application. For example, the first application may be a call application that is installed in the electronic device 100. For another example, the first application may be a call application providing a VoLTE service through an LTE data communication network.

In step 430, the electronic device 110 may display, on the display 120, an incoming call user interface provided by the first application. An incoming call user interface may include a call acceptance object, a call rejection object, and a message change object of a text or an icon.

If a designated notification event is generated, the electronic device 100 may provide a notification based on a method set to a first application. For example, if a designated notification event is generated, the electronic device 100 may output a bell sound or may generate a vibration for each designated time interval. Alternatively, the electronic device 100 may generate a bell sound or a vibration at the same time.

In step 440, the electronic device 100 may receive a call acceptance command from a user. According to an embodiment of the present disclosure, a user may input a call acceptance command through a touch sensor panel. For example, a user may input a call acceptance command by touching or dragging a call acceptance object displayed on an incoming call user interface. A user may input a user command vocally. For example, if an incoming call user interface is displayed on the display 120, the microphone 140 may be activated. The electronic device 100 may recognize a voice of a user received through the microphone 140.

If a call acceptance command is received from a user, in step 450, the electronic device 100 may display a call user interface during a call on a display.

If a call acceptance command is received from a user, in step 460, the electronic device 100 may provide a user with a conversation service through a first application. According to an embodiment of the present disclosure, if a conversation service starts, the electronic device 100 may recognize a voice of a user received through the microphone 140 and may output a response message corresponding to the voice of the user through the speaker 150.

According to an embodiment of the present disclosure, the electronic device 100 may set a vocal output mode of the speaker 150 differently, based on an input path of a call acceptance command. For example, if a call acceptance command is input through a touch sensor panel, the electronic device 100 may control the speaker 150 to operate in a normal mode. For example, if a call acceptance command is input through the microphone 140, the electronic device 100 may control the speaker 150 to operate in a speakerphone mode.

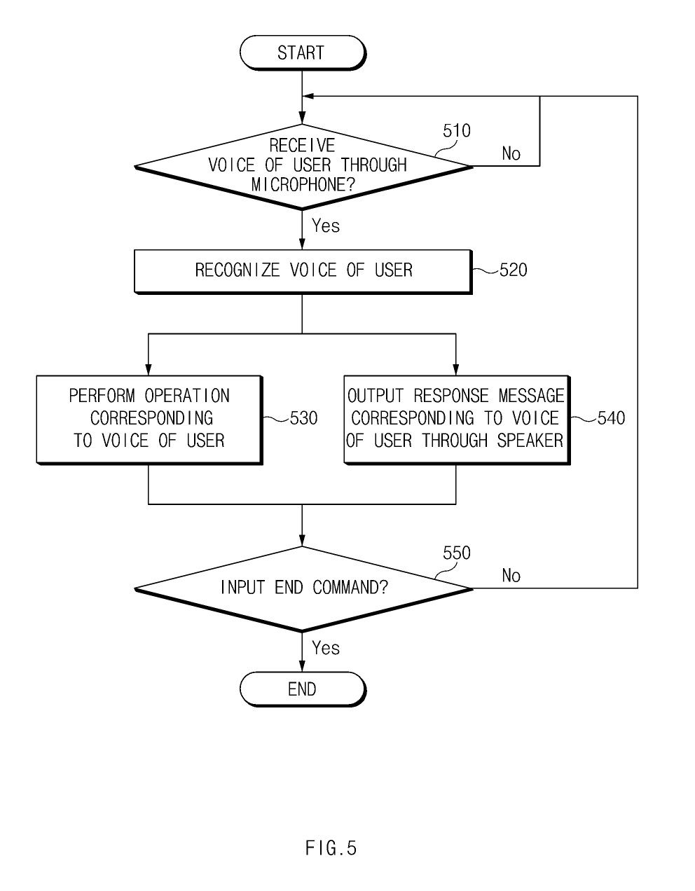

FIG. 5 is a flowchart of a method of providing a conversation service, according to an embodiment of the present disclosure.

The flowchart in FIG. 5 is an example of step 460 in FIG. 4.

Referring to FIG. 5, if a conversation service starts, in step 510, the electronic device 100 may determine whether to receive a voice input of a user through a microphone.

If a voice input of a user is received through a microphone, in step 520, the electronic device 100 may recognize the received voice input of the user.

According to an embodiment of the present disclosure, in step 530, the electronic device 100 may perform an operation corresponding to a recognized voice input of a user. For example, if a user requests a call or a message from another user, the electronic device 100 may request the other user to make a call or may send a message for making a call to the other user. For example, the electronic device 100 may add a new schedule to a schedule application. For example, if a question is received from a user, the electronic device 100 may search for an answer to the question on a web network.

According to an embodiment of the present disclosure, in step 540, the electronic device 100 may output a response message corresponding to a voice input of a user through the speaker 150. For example, the electronic device 100 may output a response to a question of a user vocally.

In step 550, the electronic device 100 may determine whether an end command is input from a user. For example, a user may input an end command with a touch manipulation or a voice input. According to an embodiment of the present disclosure, if an end command is not input from a user, in step 510, the electronic device 100 may determine whether a voice input of the user is received. If an end command is input from a user, the electronic device 100 may terminate a conversation service.

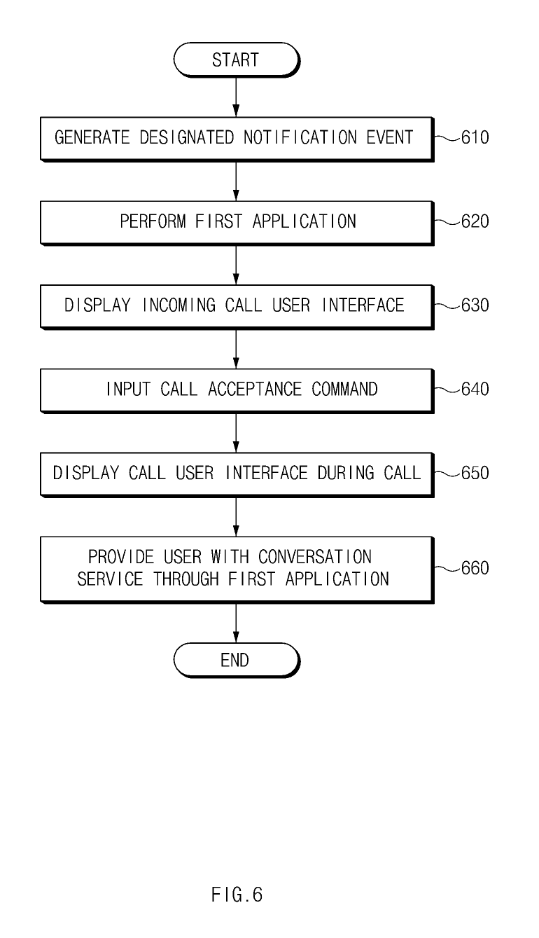

FIG. 6 is a flowchart of a notification method of an electronic device according to an embodiment of the present disclosure.

The flowchart in FIG. 6 may include operations of the electronic device 100 in FIG. 1. The above description concerning the electronic device 100 in FIG. 1 may be applied to the method in FIG. 6.

Referring to FIG. 6, in step 610, a designated notification event may be generated in the electronic device 100. According to an embodiment of the present disclosure, the electronic device 100 may determine whether a designated notification event (or an urgent notification event) is generated based on at least one of a user setting of a notification event, whether a user responds to a notification event, a location of an electronic device, a time, a word included in a notification event, or a caller of a notification event.

According to an embodiment of the present disclosure, if a notification event set to an urgent notification by a user is generated, the electronic device 100 may determine that a designated notification event is generated. If a number of responses to a notification is greater than or equal to a designated value, the electronic device 100 may determine that a designated notification event is generated. If mail or a message is received from a designated caller, the electronic device 100 may determine that a designated event is generated. If mail or a message in which a certain word is included is received, the electronic device 100 may determine that a designated event is generated. If a user approaches a location set by a user, the electronic device 100 may determine that a designated event is generated. If it is determined that a movement time for moving to a location included in a schedule is equal to a remaining time between a current time and a time included in the schedule or that the movement time is less than the remaining time, the electronic device 100 may determine that a designated notification event is generated. If a group schedule is changed, the electronic device 100 may determine that a designated notification event is generated.

If a designated notification event is generated, in step 620, the electronic device 100 may execute a first application. According to an embodiment of the present disclosure, the first application may be a call application. For example, the first application may be a call application that is installed in the electronic device 100. For example, the first application may be a call application providing a VoLTE service through an LTE data communication network.

In step 630, the electronic device 110 may display, on the display 120, an incoming call user interface provided by a first application. According to an embodiment of the present disclosure, the incoming call user interface may include a call acceptance object, a call rejection object, and a message change object of a text or an icon.

If a designated notification event is generated, the electronic device 100 may provide a notification based on a method set to a first application. For example, if a designated notification event is generated, the electronic device 100 may output a bell sound or may generate a vibration for each designated time interval. Alternatively, the electronic device 100 may generate a bell sound or a vibration at the same time.

In step 640, the electronic device 100 may receive a message change command from a user. According to an embodiment of the present disclosure, a user may input a message change command through a touch sensor panel. For example, a user may input a message change command by touching or dragging a message change object displayed on an incoming call user interface. In addition, a user may input a message change command vocally. For example, if an incoming call user interface is displayed on the display 120, the microphone 140 may be activated. Furthermore, the electronic device 100 may recognize a voice of a user received through the microphone 140.

If a message change command is input from a user, in step 650, the electronic device 100 may execute a second application. According to an embodiment of the present disclosure, the second application may be a message application. For example, the second application may be a short message service (SMS) application that is installed in the electronic device 100. For example, the second application may be an instant message application.

If a call acceptance command is received from a user, in step 660, the electronic device 100 may display a user interface including a message associated with a designated event on a display. According to an embodiment of the present disclosure, a user interface may include a message associated with a designated notification event. That is, the electronic device 100 may provide a user with information associated with a designated notification event in the form of a message. The user interface may include an object for performing an operation associated with a designated notification event. For example, the user interface may include an object of a text or an icon. If an object is selected by a user, the electronic device 100 may perform an operation corresponding to the selected object.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

The term “module” used herein may indicate, for example, a unit including one or more combinations of hardware, software and firmware. The term “module” may be interchangeably used with the terms “unit,” “logic,” “logical block,” “component” and “circuit.” The “module” may indicate a minimum unit of an integrated component or may be a part thereof. The term “module” may indicate a minimum unit for performing one or more functions or a part thereof. The term “module” may indicate a unit implemented mechanically or electronically. For example, the term “module” may indicate at least one of an application-specific integrated circuit (ASIC), a field-programmable gate array (FPGA), and a programmable-logic device for performing some operations, which are known or will be developed.

At least a part of an apparatus (e.g., modules or functions thereof) or a method (e.g., operations) according to various embodiments of the present disclosure may be, for example, implemented by instructions stored in a non-transient computer-readable storage medium in the form of a program module. If the instructions are executed by one or more processors (e.g., a control module 170), the one or more processors may perform functions corresponding to the instructions.

A non-transient computer-readable recording medium may include a hard disk, a floppy disk, a magnetic medium (e.g., a magnetic tape), an optical medium (e.g., a compact disc read only memory (CD-ROM) and a digital versatile disc (DVD), a magneto-optical medium (e.g., a floptical disk), and a hardware device (e.g., a read only memory (ROM), a random access memory (RAM), or a flash memory). Also, a program instruction may include not only machine generated code such as code generated by a compiler but also high-level source code executable on a computer using an interpreter. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included therein. Operations executed by modules, program modules, or other elements may be executed by a successive method, a parallel method, a repeated method, or a heuristic method. Also, a part of the operations may be executed in different sequences, omitted, or other operations may be added.

According to various embodiments of the present disclosure, in the case of an urgent or important notification event, a notification may be provided to a user based on a manner in which an incoming call is received by using a call application that users frequently use. Moreover, the electronic device may provide a user with a natural user experience, for example, making a call by providing a user with a conversation service associated with a notification event.

While the present disclosure has been shown and described with reference to various embodiments thereof, it will be understood by those skilled in the art that various changes in form and details may be made therein without departing from the scope of the present disclosure as defined by the appended claims and their equivalents.

What is claimed is:

1. An electronic device, comprising:
an input module configured to receive a user input;
a display configured to display a user interface; and
a processor configured to execute a first application if a notification event is generated, display an incoming call user interface provided by the first application, on the display, and provide a user with a conversation service through the first application if a call acceptance command is input from the user.

2. The electronic device of claim 1, wherein the processor is further configured to determine whether the notification event is generated, based on at least one of a user setting of the notification event, and whether the user responds to the notification event, a location of the electronic device, a time, a word included in the notification event, or a caller of the notification event.

3. The electronic device of claim 1, further comprising:
a speaker configured to output sound; and
a motor configured to generate a vibration,
wherein the processor is further configured to generate at least one of the sound or the vibration based on a notification method set to the first application if the notification event is generated.

4. The electronic device of claim 1, wherein the processor is further configured to display a call user interface provided by the first application while the conversation service is provided, on the display if the call acceptance command is input.

5. The electronic device of claim 1, further comprising:
a microphone configured to receive a voice input of the user; and
a speaker configured to output sound,
wherein the processor is further configured to recognize the voice input of the user received through the microphone and to output a response message corresponding to the voice of the user through the speaker if the conversation service is provided.

6. The electronic device of claim 5, wherein the input module comprises a touch sensor panel configured to sense a touch manipulation of the user, and
wherein the processor is further configured to control the speaker to operate in a normal mode if the call acceptance command is input through the touch sensor panel and to control the speaker to operate in a speakerphone mode if the call acceptance command is input through the microphone.

7. The electronic device of claim 1, further comprising:
a microphone configured to receive a voice input of the user,
wherein the processor is further configured to recognize the voice input of the user received through the microphone and to perform an operation corresponding to the recognized the voice input of the user if the conversation service is provided.

8. The electronic device of claim 7, wherein the processor is further configured to perform at least one of a call requesting operation, a message sending operation, a schedule adding operation, or a web search operation based on the recognized voice input of the user.

9. The electronic device of claim 1, wherein the processor is further configured to display, on the display, a user interface including a message associated with the notification event by executing a second application if a message change command is input from the user while the incoming call user interface is displayed on the display.

10. The electronic device of claim 9, wherein the user interface including the message associated with the notification event comprises an object for performing an operation associated with the notification event.

11. A notification method of an electronic device, the method comprising:
executing, by the electronic device, a first application if a notification event is generated;
displaying, on a display, an incoming call user interface provided by the first application;
receiving, by the electronic device, a call acceptance command from a user; and
providing, by the electronic device, the user with a conversation service through the first application.

12. The method of claim 11, further comprising determining whether the notification event is generated based on at least one of a user setting of the notification event, and whether the user responds to the notification event, a location of the electronic device, a time, a word included in the notification event, or a caller of the notification event.

13. The method of claim 11, further comprising:
generating at least one of sound or a vibration based on a method set to the first application if the notification event is generated.

14. The method of claim 11, further comprising:
displaying, on the display, a call user interface provided by the first application while the conversation service is provided if the call acceptance command is input.

15. The method of claim 11, wherein providing the user with a conversation service comprises:
recognizing a voice input of the user received through a microphone; and
outputting a response message corresponding to the voice input of the user through a speaker.

16. The method of claim 15, wherein outputting the response message comprises:
outputting the response message in a normal mode if the call acceptance command is input through a touch sensor panel; and
outputting the response message in a speakerphone mode if the call acceptance command is input through the microphone.

17. The method of claim 11, wherein providing the user with a conversation service comprises:
recognizing a voice input of the user received through a microphone; and
performing an operation corresponding to the recognized voice input of the user.

18. The method of claim 17, wherein performing the operation corresponding to the recognized voice input of the user comprises performing at least one of a call requesting operation, a message sending operation, a schedule adding operation, or a web search operation based on the recognized voice input of the user.

19. The method of claim 11, further comprising:
receiving a message change command from the user while the incoming call user interface is displayed on the display; and
displaying, on the display, a user interface including a message associated with the notification event by executing a second application.

20. The method of claim 19, wherein the user interface including the message associated with the notification event comprises an object for performing an operation associated with the notification event.
